(19) United States
(12) Patent Application Publication
(10) Pub. No.: US 2022/0215136 A1
(43) Pub. Date: Jul. 7, 2022

(54) SYSTEM AND METHOD FOR MULTI-USER SPATIAL IMPACT ANALYSIS AND MANAGEMENT

(71) Applicant: Siemens Industry Software Inc., Plano, TX (US)

(72) Inventors: Raman Garimella, Tustin, CA (US); Prabath Vemulapalli, Fullerton, CA (US)

(21) Appl. No.: 17/611,978

(22) PCT Filed: Jun. 10, 2019
(86) PCT No.: PCT/US2019/036323

§ 371 Date: Nov. 17, 2021

(51) Int. Cl. G06F 30/15

(52) U.S. Cl. CPC G06F 30/15; G06F 2119/18

(57) ABSTRACT

Methods for CAD operations and corresponding systems and computer-readable mediums are disclosed herein. A method includes accessing (302), by a data processing system (202, 500), a computer-aided design, engineering, visualization, or manufacturing (CAx) model (208) of a part or assembly to be manufactured. The method includes storing (304) a plurality of impact definitions (204) corresponding to the CAx model (208). The method includes receiving (306), from a first client system (220A), an indication of a first spatial area of the CAx model (208) and, from a second client system (220B), an indication of a second spatial area of the CAx model (208). The method includes receiving (308) a notification of a save event created by the first client system (220A) for the first spatial area. The method includes performing impact detection (310) according to the save event, the first spatial area, and the impact definitions (204) to detect a potential impact. The method includes sending (312) an impact notification to the first client system (220A) and the second client system (220B).

### TECHNICAL FIELD

The present disclosure is directed, in general, to computer-aided design, engineering, visualization, and manufacturing systems (“CAD systems” or “CAx systems”), product lifecycle management (“PLM”) systems, and similar systems, that manage data for products and other items (collectively, “Product Data Management” systems or PDM systems).

### BACKGROUND OF THE DISCLOSURE

CAD systems are useful for designing and visualizing two-dimensional (2D) and three-dimensional (3D) models and drawings for manufacture as physical products, including massive-model assemblies with thousands or millions of components. Improved systems are desirable.

### SUMMARY OF THE DISCLOSURE

Various disclosed embodiments include a method for CAD operations and corresponding systems and computer-readable mediums. A method includes accessing a computer-aided design, engineering, visualization, or manufacturing (CAx) model of a part or assembly to be manufactured by a data processing system. The method includes storing a plurality of impact definitions corresponding to the CAx model. The method includes receiving, from a first client system, an indication of a first spatial area of the CAx model and, from a second client system, an indication of a second spatial area of the CAx model. The method includes receiving a notification of a save event created by the first client system for the first spatial area. The method includes performing impact detection according to the save event, the first spatial area, and the impact definitions to detect a potential impact. The method includes sending an impact notification to the first client system and the second client system. While exemplary processes are described in the context of two client systems, those of skill in the art will recognize that any number of client systems or other systems as described herein can be used.

In various embodiments, the save event identifies a part or assembly in the first spatial area that has had geometry or component changes. In various embodiments, performing the impact detection includes performing a where-used query on the part or assembly to determine where-used results, determining whether the where-used results correspond to an impact definition, and, for each where used result that corresponds to an impact definition, evaluating the geometry or component changes with respect to the impact definitions to identify the potential impact. In various embodiments, the first client system thereafter displays impact results. Various embodiments also include sending the impact notification to a collaboration client. In various embodiments, sending an impact notification to the first client system and the second client system includes sending the impact notification to a message broker that publishes the impact notification to the first client system and second client system. In various embodiments, the notification of a save event is received from a message broker. In various embodiments, the first client system displays a 3D graphical feedback to a user illustrating the potential impact. In various embodiments, the first client system displays an impact analysis dashboard that includes collective or historical information of impacts over time. In various embodiments, the impact notification includes one or more of an identifier of a client that produced the save event that resulted in the impact notification, a name or type of design tool that produced the save event that resulted in the impact notification, a spatial area affected by the save event that resulted in the impact notification, universal identifiers of any parts or components changed, added, or deleted by the save event that resulted in the impact notification, geometric, CAx, or other data that can be used to display the potential impact, or a username or other identifier of a user of a client that produced the save event that resulted in the impact notification.

Various disclosed embodiments also include a data processing system including a processor. The data processing system also includes an accessible memory. The data processing system is particularly configured to perform processes as described herein.

Various disclosed embodiments further include a non-transitory computer-readable medium encoded with executable instructions that, when executed, cause one or more data processing systems to perform processes as described herein.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates an example of a portion of a complex model of an airplane with many systems in the same spatial area that can be processed in accordance with disclosed embodiments;

FIG. 2 illustrates a block diagram of a conflict analysis system in accordance with disclosed embodiments;

FIG. 3 illustrates a flowchart of a process in accordance with disclosed embodiments;

FIG. 4 illustrates an exemplary impact detection process that can be performed by the system in accordance with disclosed embodiments; and

FIG. 5 illustrates a block diagram of a data processing system in which an embodiment can be implemented.

### DETAILED DESCRIPTION

The figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In industries such as (but not limited to) automotive, aerospace, heavy machinery, and marine, CAD models of these often-massive assemblies are developed and modified by cross-functional CAD designers concurrently working in a tight spatial area of the model. For example, structures designers, electrical systems designers, HVAC designers, and others, may all be working in the same spatial area of the product model. In such scenarios, there is typically a contention for space between these cross-functional designers where two parts of the assembly “collide” within the model space. The following are a few scenarios on how these conflicts can go undetected until later in the design process.

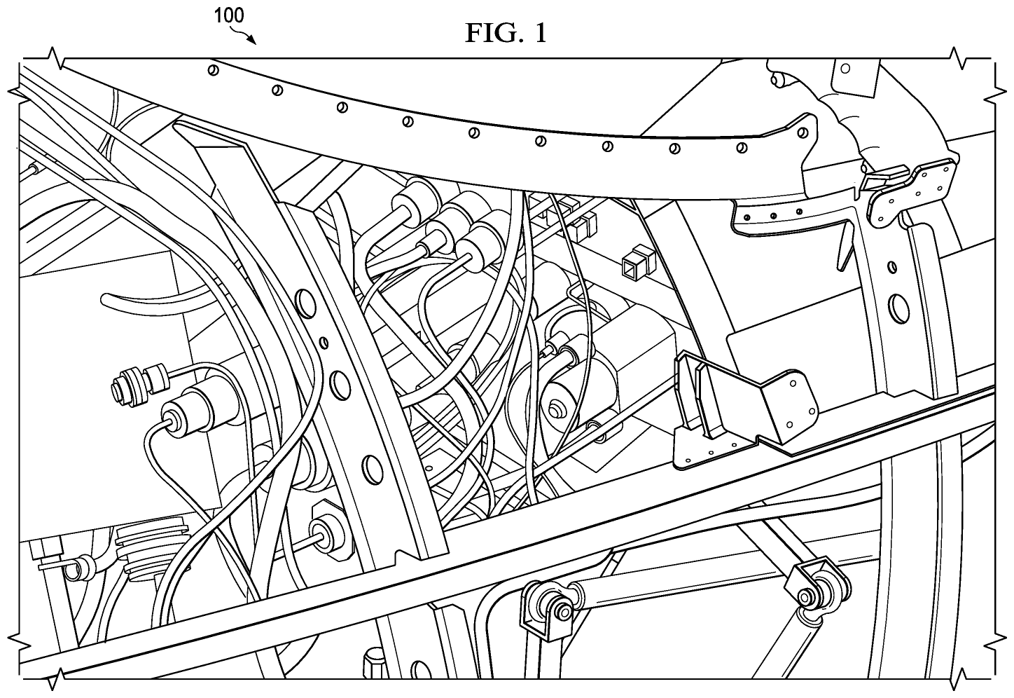

FIG. 1 illustrates an example of a portion of a complex model 100 of an airplane with many systems in the same spatial area.

In most desktop CAD systems, once the design is loaded into the system, the user is isolated from what other users are doing. This means that designers working concurrently can make conflicting design changes by occupying the same spatial area in the product.

A change that a user has made in the context of one variant of a product (e.g., the base model of a car) might conflict with other variants of the product (e.g., the sports or coupe model of the car). In such a conflict, using this example, the model may represent a “collision” where a part of the sports-model assembly collides with a portion of the base-model assembly. Because each user mar may be operating independently, these collisions are not visible to either designer.

The conflicts also might not be visible due to business-process reasons where cross-functional design teams see each other's work only when specific milestones are achieved in the design process, and the whole model of the product goes through a review process.

The conflicts include conflicts that are not an actual “collision” of solid bodies, such as conflicts that violate design constraints. For example, a conflict might result from a violation of compliance or safety requirements assigned to a particular system. E.g., safety reasons might dictate specific clearance needs to be maintained around a particular piece of electrical equipment.

These design conflicts may only be reconciled during a review that happens much later in the design process. This may be accomplished, for example, by running batch clearance checks that inspect the entire product on a periodic basis. This approach requires dedicated hardware infrastructure and dedicated staff to review results and determine the root cause of an issue. This is an expensive and time-consuming process and requires multiple design iterations spread over a longer period of time in order to achieve a resolution.

Delayed conflict checks can result in expensive rework of designs, and potentially increase product development costs, and cause in delays in execution. Disclosed embodiments include systems and methods that detect such conflicts and provide users with immediate feedback on impact as soon as such a conflict occurs. This enables resolution of conflicts much earlier in the design process and results in significant savings in product development costs.

Disclosed embodiments include a system and method for 3D spatial impact analysis. Various embodiments are implemented as a high performance and scalable cloud service that automatically detects and analyzes spatial conflicts to deliver real-time notifications to client systems and their users. These notifications can include graphical feedback about the design change and the authoring user. Various embodiments can include live “dashboards” on client systems that provide system engineers a view into current and historical issues

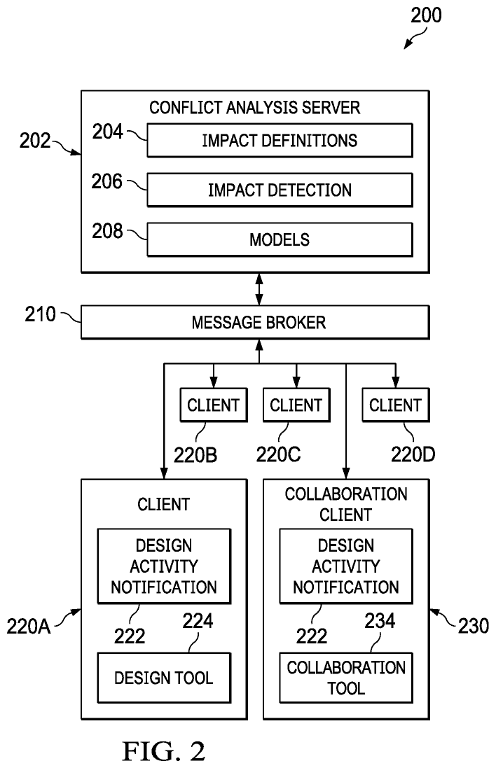

FIG. 2 illustrates a block diagram of a conflict analysis system 200 in accordance with disclosed embodiments. In this example, and as described in more detail below, a conflict analysis server 202 executes an impact definition process 204 and an impact detection process 206. Conflict analysis server 202 can also store models 208, which can be or include any CAx models or data reflecting products, assemblies, spatial areas, or other data as described herein, and can be include references to any CAx models or data reflecting products, assemblies in a PDM system.

That is, in some embodiments, CAx models 208 may refer to other data residing on a different physical system, such as a PDM system, one example of which is the TEAMCENTER software product by Siemens Product Lifecycle Management Software Inc. Conflict analysis server 202 can store a reference to the models in the PDM system and a corresponding spatial area definition as models 208.

Conflict analysis server 202 communicates with a message broker system 210. Message broker system 210 communicates with a plurality of clients 220, including in this example clients 220A, 220B, 220C, and 220D. While four clients 220 are illustrated in this example, those of skill in the art will recognize that more or fewer clients can be used in any particular implementation.

While this example shows message broker system 210 as a separate physical system from conflict analysis server 202, in other implementations the message broker system 210 is implemented as a process executing on conflict analysis server 210.

Any of the communications between various systems and elements illustrated in FIG. 2 can be performed over any wired or wireless network or communication protocol. In particular, in specific embodiments, conflict analysis server 202 and message broker 210 are implemented as “cloud” servers/services, so that the processes described herein by conflict analysis server 202 are offloaded from the client systems and as performed in a scalable, cloud-based architecture. Similarly, any of the data or processes described with relation to the various components can be performed by individual data processing systems or by multiple data processing systems in communication to together act as a system described herein. Unless specifically indicated otherwise, references to “a” data processing system are intended to include multiple physical data processing systems acting in coordination to perform the described operations or functions.

Message broker system 210 performs high performance transmission of messages between distributed systems including conflict analysis server 202 and clients 220. Message broker system 210 can be implemented, in some cases, using such commercial off-the-shelf (COTS) software products as the RABBITMQ open-source message-broker software of Pivotal software, the APACHE ACTIVEMQ open source message broker software of the Apache Software Foundation, or APACHE KAFKA open-source stream-processing software platform of the Apache Software Foundation. In the context of the design activity notification system, the message broker supports the transmission of messages between CAx clients 220 and the other elements described herein. Message brokers can work on a “publish and subscribe” pattern where there is a publisher system that sends a message and many subscriber systems that can receive this message. A subscriber system can specify filters on what messages can be received by it.

The messaging between clients 220, the message broker 210, and the conflict analysis server 202 can be in any format as usable to perform the processes described herein.

As illustrated in this example of client 220A, each of the client 220 can execute a number of software processes. In particular, each client 220 executes a design tool 224, which can be any CAD/CAM/CAE or other application or process for product design or analysis that can use a spatial impact analysis as described herein. The design tool 224 can also include PLM clients (such as the ACTIVE WORKSPACE and TEAMCENTER software products of Siemens Product Lifecycle Management Software Inc.) and collaboration tools.

Conflict analysis system 200 can also include one or more collaboration clients 230 that do not themselves include a design tool 224, but instead have a collaboration tool 234. Collaboration tool 234 can be any commercial or proprietary collaboration or communication tool. A collaboration client 230, which can be any data processing system including portable devices such as a smart phone or tablet, which may or may not support a full design tool 224, but still enables communication using collaboration tool 234.

Each client 220 and collaboration client 230 also executes a design activity notification 222. Design activity notification 222 can be implemented as a separate software process from design tool 224 or can be integrated with design tool 224. Similarly, design activity notification 222 can be implemented as a separate software process from collaboration tool 234 or can be integrated with collaboration tool 234. Design activity notification 222 monitors the use of design tool 224 to communicate spatial issues to message broker 210, as described herein, and to notify design tool 224 and/or the user of issues and notifications communicated from message broker 210. Design activity notification 222 facilitates the real-time transmission of design activity notifications published by design tools 224 on each client 220. These notifications can be received by other clients 220 or can be received by the message broker 210 to be forwarded to other clients 220 and/or conflict analysis server 202.

On collaboration clients 230, collaboration tool 234 can receive and process messages from any other client 220, collaboration client 230, message broker 210, or conflict analysis server 202 and communicate those messages to collaboration tool 234. This enables the users of collaboration client 230 to keep informed of such issues as potential spatial impacts even if they are not using a design tool 224. The same is true when a user is “logged in” to a collaboration tool 234 but not a design tool 224 on any given system, so that the user still receives relevant messaging even when not using design tool 224.

Design activity notification 222 on each client 220 or collaboration client 230 can act as a client-side adapter to translate, convert, or process messages as necessary for the specific client. Design activity notification 222 can publish messages, including capturing design activity events that are executed by a user, packaging the events into the notification message format, and/or publishing the message to the message broker. Design activity notification 222 can receive messages, including displaying notifications to a user via a Graphical User Interface (GUI) and/or transmitting notifications via pre-configured message channels, for example in commercial collaboration tools.

Design activity notification 222 can also provide significant advantages over other systems even apart from the spatial impact analysis processes described herein. For example, it provides the means for exchange of notifications about any type of activity that is of interest—e.g., check-in/check-out of CAx documents, notification of parts that were saved since last loaded, notifications when new revisions are available, and others.

In specific embodiments, disclosed systems and methods include a messaging format for defining each event that occurs in a design session. Each message can act as a “contract” that will facilitate multiple clients 220 to consume the messages that are generated by design tool 224. The messaging format also specifies the message attributes that can be used for filtering messages during subscriptions. In these embodiments, the event message format contains fields or data for a context, a user, a type, and event data.

The “context” identifies a CAx object associated with an event, which can be, for example, a CAx document or a handle to a CAx object in a database. Since, in disclosed embodiments, multiple clients are each operating on a common CAx model and environment, each of the clients 220 and the conflict analysis server 202 have access to the same CAx databases storing that data (or mirrors/replications of such data).

The “user” identifies the user associated with the event. The “type” describes an event type that allows clients 220 to implement specific handlers based on the event type. The “event data” includes additional data that describes information relevant to a specific event.

Conflict analysis system 200 can implement a scalable cloud service, deployable on both public-network systems, private cloud systems, in an on-premise datacenter, or in some combinations of these. The cloud-based conflict analysis server 202 provides an impact definition 204. Impact definition 204 is a cloud-based service capability that can be exposed via a representational state transfer application program interface (RESTful API) that allows an application to specify information that contains the notion of a user and a spatial area in a CAD assembly that represents a product. The area can be defined explicitly, such as a 3D bounding box or an irregular volume, or implicitly, as derived from an engineering requirement captured in a requirements management system. An implicit area definition is particularly useful for checking against compliance or safety regulations. There can be multiple discrete areas of interest spread across multiple products. This information can be stored persistently in a cloud database (whether on conflict analysis server 202 or on a separate database server) to facilitate fast access.

The cloud-based conflict analysis server 202 provides an impact detection 206 as described in more detail below, which applies the impact definitions 204 to determine impacts between the spatial areas being processed by different users.

In specific embodiments, as disclosed herein, the impact notification is sent by the conflict analysis server 202 to the message broker 210. The message broker 210 then sends impact notification messages to the first and second client systems and any other client 220 that should be notified of the impact notification. Further, message broker 210 can send the impact notification to one or more collaboration client 230, for example to notify users of the potential impact even if those users are not presently using a design tool 224 to edit a spatial area. In each case, in specific embodiments, design activity notification 222 can receive the impact notification messages and provide notification to the user of the respective system, such as displaying a warning of the potential impact, displaying the changes made to the model by the save event that generated the potential impact, or otherwise.

Disclosed embodiments can provide real-time 3D graphical feedback to the user by each client 220. The spatial impact notification from conflict analysis server 202 is received by the design tools 222 or the design activity notification 222 of all clients 220 that are impacted by a change, as well as the client 220 that caused the change. The user associated with each client 220 will be provided with 3D graphical feedback that will show a preview of the conflicting change, and a representation of the user who caused the conflict. This will then facilitate users to work together to take immediate corrective action.

Disclosed embodiments can provide spatial impact reports and dashboards. Design activity notification 222 can include a collaboration tools adapter that publishes the notifications to standard COTS collaboration tools. This facilitates notification and review of issues outside of the design tool 224. In addition, in various embodiments, each of the clients 220, the message broker 210, and/or the conflict analysis server 202 can capture the spatial impact notifications and store them in an impact analysis results database, which may be physically implemented on any of these devices or on a separate database server. These spatial impact notifications can then be used to populate live dashboards that will allow lead engineers in an organization to have a view of areas of the product that have spatial conflicts. Reports such as the areas of the product with the most spatial conflicts can be presented. These reports will help identify potential areas of improvement.

Disclosed embodiments provide a complete end to end solution that supports immediate detection, analysis, and management of spatial conflicts. This significantly reduces the costs of product development, improves efficiency, reduces the potential for conflicts, reduces time to market, among many other benefits by finding issues much earlier in the design cycle.

Design activity notification 222 and multi-user spatial impact analysis service provided by conflict analysis server 202 provide key technical pieces that enable increased efficiency in product design. The usage of message broker 210 and cloud services technology enables the performance and scalability needed to support real-time computation of special impacts.

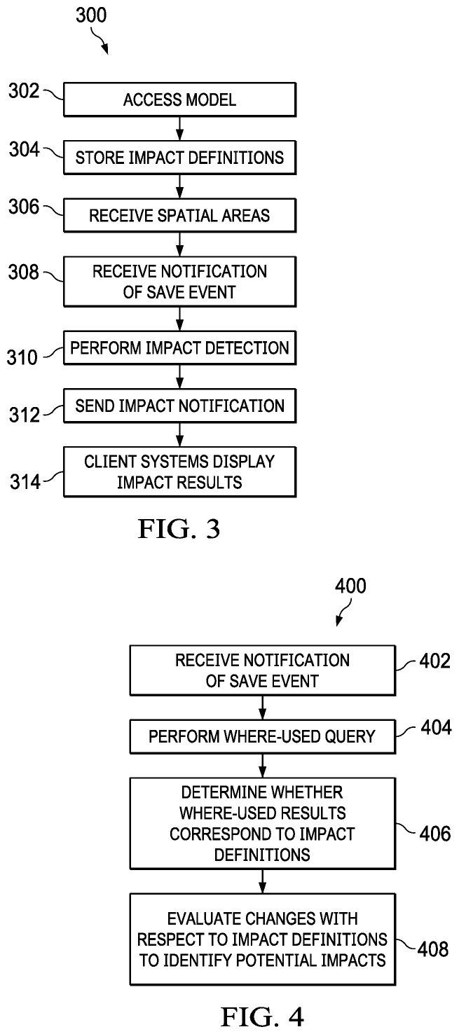

FIG. 3 illustrates a flowchart of a process 300 in accordance with disclosed embodiments, as may be performed by a conflict analysis system 200, referred to generically as the “system” below.

The system accesses a CAx model (302). The CAx model can be for a part or assembly to be manufactured. The model can be a 3D solid model or another data structure that defines such a 3D solid model. The model can be stored, for example, in a storage of conflict analysis server 202 or in a separate database server such as a PDM system. In a cloud implementation, of course, a separate database server can logically be considered part of the conflict analysis server 202. In various embodiments, the stored model or references to the stored model is maintained on the system and can be viewed, edited, or manipulated by multiple client systems.

The system stores a plurality of impact definitions corresponding to the CAx model (304). The impact definitions define, explicitly or implicitly, spatial impact between objects in a spatial area of the model. For example, an impact definition can define that two physical bodies cannot occupy the same 3D space (that is, an actual “collision” between objects). As another example, an impact definition can define that areas that are occupied in certain variants of the model so that collisions or other impacts are avoided in other variants of the model. As another example, an impact definition can define preset tolerances or distances required between components of the model, and these can vary by type of component (e.g., small distances can be required between purely structural components, while larger distances can be required between electrical or heat-generating components). The spatial impacts defined by the impact definitions can include actual forbidden conflicts (such as a collision between objects) and impacts that may be acceptable but of which the users should be alerted (such as close tolerances, heat exchanges, electrical issues, or otherwise).

The system receives from a first client system an indication of a first spatial area of the model and from a second client system an indication of a second spatial area of the CAx model (306). Both the first spatial area and the second spatial area can be subsets of the spatial area occupied by the model; that is, the first and second spatial areas are generally portions of the overall model on which the users of the first and second client systems will be working. The first and second spatial areas can be identical or different, but they share some common spatial area for purposes of this process. That is, the first and second spatial areas could be identical, but in most cases they will be different but have some overlapping space, or in other cases one of the received spatial areas can be a subset of the other spatial area. While only two clients and corresponding spatial areas are used in this example, those of skill in the art will recognize that the techniques disclosed herein apply to any number of clients and corresponding spatial areas being used by the clients. The system can also create or modify impact definitions based on the received first and second spatial areas.

In a general operation, a client system will download and create a local copy of a specific spatial area of the model to be viewed or worked on. That is, when a user on a client system desires to work on a model, the client system may attempt to retrieve the entire model, which can include thousands or millions of components and can be inefficient to transfer to the client and difficult or impossible for the client system to effectively manage. Instead, the client system only retrieves a limited spatial area for editing and creates a local working copy of that spatial area. Occasionally, the client system saves any changes to the local working copy back into the model, either automatically or manually. Since different client systems are using different local copies, the edits they make may conflict. At 306, each client system informs the conflict analysis server of the spatial area of the model for which it is creating a local working copy.

In specific embodiments, as disclosed herein, these indications are received as messages from the message broker. That is, the first and second clients 220 send messages to the message broker 210, using the design activity notification 222, and the message broker 210 sends messages to be received by the conflict analysis server 202.

The system receives a notification of a save event created by the first client system for the first spatial area (308). As described herein, each client system will occasionally save edits to its corresponding spatial area back to the model. When this occurs, the system receives a notification that the spatial area for that client has been saved or otherwise updated. Note that “save” event is intended to include any event that indicates that the client system has updated or changed the shared model.

In specific embodiments, as disclosed herein, these notifications are received as messages from the message broker. That is, the first and second clients 220 send notifications to the message broker 210, using the design activity notification 222, that indicates that the design tool 224 on the respective client 220 has executed a save event. The message broker 210 sends messages to be received by the conflict analysis server 202 that act as the notification of the save event. The notification of the save event can be published by the first client system where the conflict analysis server is a subscriber to such notifications.

The notification of the save event can include any relevant data, such as the client 220 that produced the save event, the name or type of design tool that produced the save event, the spatial area affected by the save event, universal identifiers of any parts or components changed, added, or deleted by the change event, the username or other identifier of the user of the client that produced the save event, or other data.

The system performs impact detection according to the save event, the first spatial area, and the impact definitions to detect a potential impact (310). In response to receiving the save event notification, the system analyzes the edited/saved portion of the model corresponding to the first spatial area and applies the impact definitions to detect potential impacts. Of course, not every save event will produce a potential impact, so some iterations of this process may end with performing impact detection, then return to 308 to await the next save notification.

FIG. 4 illustrates an exemplary impact detection process 400 that can be performed by the system in accordance with disclosed embodiments.

The system receives the notification of the save event as in 308 (402). The save event can include any of the data described above and can reflect the save of any CAD part or assembly in the spatial area that has had geometry or component changes. The geometry or component changes can include geometry or component position changes, which could cause actual “collision” conflicts or violate other impact-definition constraints or tolerances, and can include other changes, such as changes to the material used for building the component, such that an impact or conflict would then occur between it and other parts and components. These changes can include changes to any material properties, such as electrical or heat conductivity, strength, flexibility, or brittleness of the material, heat response, porousness, breathability, corrosion resistance, reactivity, or other magnetic, mechanical, electrical, optical, or thermal properties.

The system performs a where-used query on the part or assembly of the model to determine where-used results (404).

The system determines whether the where-used results correspond to an impact definition (406).

For each where used result that corresponds to an impact definition, the system evaluates the geometry or component changes with respect to the impact definitions to identify potential impacts (408).

The system can then send impact notifications as described below.

Returning to the process of FIG. 3, the system sends an impact notification to the first client system and the second client system (312). The impact notification can include any relevant data, such as the client 220 that produced the save event that resulted in the impact notification, the name or type of design tool that produced the save event that resulted in the impact notification, the spatial area affected by the save event that resulted in the impact notification, universal identifiers of any parts or components changed, added, or deleted by the save event that resulted in the impact notification, geometric, CAD, or other data that can be used to display the potential impact, the username or other identifier of the user of the client that produced the save event that resulted in the impact notification, or other data. Sending the impact notification can be publishing the impact notification to all subscribed client systems or users.

By allowing each client 220 and collaboration client 230 to subscribe to notices for specific models or spatial areas, the users of these systems can synchronize and coordinate their project tasks and eliminate unforeseen conflicts.

In response to receiving the impact notification, the first client system, the second client system or any other system that received the impact notification can then display impact results (314). The impact results can include such information as the potential impact, the username or other identifier of the user of the client that produced the save event that resulted in the impact notification, or other data. The impact results can include 3D graphical feedback displayed to a user illustrating the potential impact and can include a live impact analysis dashboard that shows such information as the type, frequency, or spatial area of impacts, the users or CAx types that produced the impacts, or other collective or historical information of impacts over time.

Disclosed embodiments improve over existing systems by providing design activity notification processes that can be implemented with an open message format, which facilitates the exchange of activity events between CAx, PLM and collaboration clients. This is particularly valuable since it provides a complete system for real-time transmission of CAx events across different clients and supports use cases where users are notified even if they are not logged into a CAx client.

The multi-user spatial impact analysis service provided by conflict analysis server 202 improves on existing systems in a number of ways. For example, disclosed embodiments include the capability to perform instant analysis of spatial conflicts between areas of interest associated to users and provides immediate feedback via multiple mechanisms such as graphical notifications via CAx clients, and notifications published to PLM and collaboration clients to support offline access by CAx users.

Disclosed embodiments provide instant detection of multi-user spatial conflict across all usages of a CAD part or assembly in multiple configurations of product assemblies, and support both explicit definition of spatial areas of interest such as a 3D bounding box, an irregular volume, and implicit areas that are defined by engineering requirements. The disclosed spatial impact analysis methods such as instant 3D graphical feedback in a CAx client as well as the live impact analysis dashboard provide specific, unique improvements by enabling real-time graphical feedback of conflicts as they happen and providing lead engineers the means to drill down quickly into areas of the product that have the most issues. The usage of cloud services and message broker is a unique technical strategy that provides the scalability needed to meet the instant impact analysis computation needed by the systems.

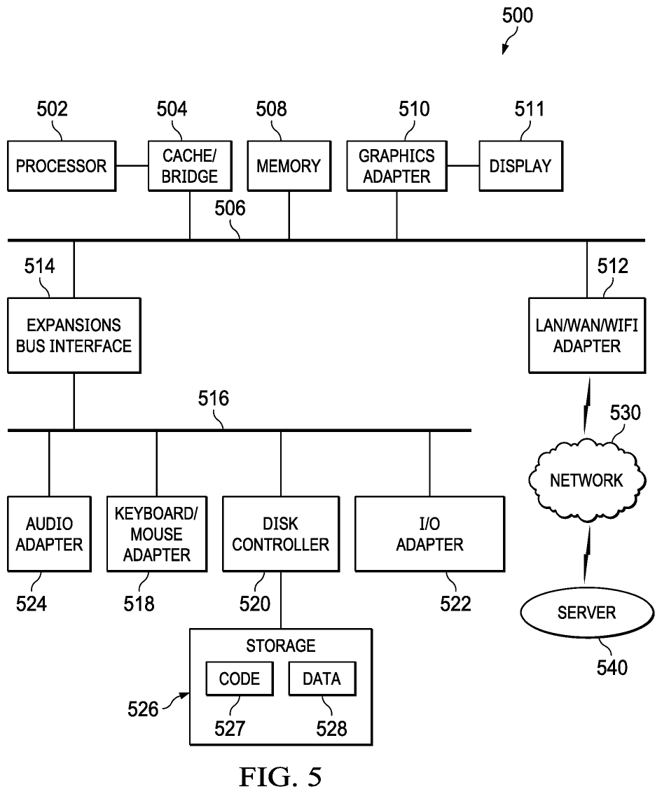

FIG. 5 illustrates a block diagram of a data processing system 500 in which an embodiment can be implemented, for example as a CAx or PDM system particularly configured by software or otherwise to perform the processes as described herein, and in particular as each one of a plurality of interconnected and communicating systems as described herein. The data processing system depicted includes a processor 502 connected to a level two cache/bridge 504, which is connected in turn to a local system bus 506. Local system bus 506 may be, for example, a peripheral component interconnect (PCI) architecture bus. Also connected to local system bus in the depicted example are a main memory 508 and a graphics adapter 510. The graphics adapter 510 may be connected to display 511.

Other peripherals, such as local area network (LAN)/Wide Area Network/Wireless (e.g. Wi-Fi) adapter 512, may also be connected to local system bus 506. Expansion bus interface 514 connects local system bus 506 to input/output (I/O) bus 516. I/O bus 516 is connected to keyboard/mouse adapter 518, disk controller 520, and I/O adapter 522. Disk controller 520 can be connected to a storage 526, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. Storage 526 can store any CAD data, models, variables, impact definitions, spatial areas, notifications, results, or other information or data discussed herein or useful for performing processes as discussed herein, shown as data 528, and any executable code or instructions usable for performing processes as described herein, shown as code 527.

Also connected to I/O bus 516 in the example shown is audio adapter 524, to which speakers (not shown) may be connected for playing sounds. Keyboard/mouse adapter 518 provides a connection for a pointing device (not shown), such as a mouse, trackball, track pointer, touchscreen, etc.

Those of ordinary skill in the art will appreciate that the hardware depicted in FIG. 5 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windowsυ, a product of Microsoft Corporation located in Redmond, Wash. may be employed if suitably modified. The operating system is modified or created in accordance with the present disclosure as described.

LAN/WAN/Wireless adapter 512 can be connected to a network 530 (not a part of data processing system 500), which can be any public or private data processing system network or combination of networks, as known to those of skill in the art, including the Internet. Data processing system 500 can communicate over network 530 with server system 540, which is also not part of data processing system 500, but can be implemented, for example, as a separate data processing system 500, including as a PDM system or another CAx system. Similarly, data processing system 500 can communicate over network 530 with any other system as described herein.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 500 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

The following documents describe other approaches to addressing CAD issues and are hereby incorporated by reference: United States Patent Publications 2016/0246899 and 2014/0317589, and U.S. Pat. No. 9,648,059.

None of the description in the present application should be read as implying that any particular element, step, or function is an essential element which must be included in the claim scope: the scope of patented subject matter is defined only by the allowed claims. Moreover, none of these claims are intended to invoke 35 USC § 112(f) unless the exact words “means for” are followed by a participle.

1. A method comprising:
accessing, by a data processing system, a computer-aided design, engineering, visualization, or manufacturing (CAx) model of a part or assembly to be manufactured;
storing a plurality of impact definitions corresponding to the CAx model;
receiving, from a first client system, an indication of a first spatial area of the CAx model and, from a second client system, an indication of a second spatial area of the CAx model;
receiving a notification of a save event created by the first client system for the first spatial area;
performing impact detection according to the save event, the first spatial area, and the impact definitions to detect a potential impact; and
sending an impact notification to the first client system and the second client system.

2. The method of claim 1, wherein the save event identifies a part or assembly in the first spatial area that has had geometry or component changes, and
wherein performing the impact detection includes:
performing a where-used query on the part or assembly to determine where-used results;
determining whether the where-used results correspond to an impact definition; and
for each where used result that corresponds to an impact definition, evaluating the geometry or component changes with respect to the impact definitions to identify the potential impact.

3. (canceled)

4. (canceled)

5. The method of claim 1, wherein sending an impact notification to the first client system and the second client system includes sending the impact notification to a message broker that publishes the impact notification to the first client system and second client system.

6. The method of claim 1, wherein the notification of a save event is received from a message broker.

7. The method of claim 1, wherein the first client system displays a 3D graphical feedback to a user illustrating the potential impact.

8. The method of claim 1, wherein the first client system displays an impact analysis dashboard that includes collective or historical information of impacts over time.

9. The method of claim 1, wherein the impact notification includes one or more of an identifier of a client that produced the save event that resulted in the impact notification, a name or type of design tool that produced the save event that resulted in the impact notification, a spatial area affected by the save event that resulted in the impact notification, universal identifiers of any parts or components changed, added, or deleted by the save event that resulted in the impact notification, geometric, CAx, or other data that can be used to display the potential impact, or a username or other identifier of a user of a client that produced the save event that resulted in the impact notification.

10. (canceled)

11. (canceled)

12. A system comprising:
a processor; and
a non-transitory machine-readable medium storing instruction that, when executed by the processor, cause a computing system to:
access a computer-aided design, engineering, visualization, or manufacturing (CAx) model of a part or assembly to be manufactured;
store a plurality of impact definitions corresponding to the CAx model;
receive, from a first client system, an indication of a first spatial area of the CAx model and, from a second client system, an indication of a second spatial area of the CAx model;
receive a notification of a save event created by the first client system for the first spatial area;
perform impact detection according to the save event, the first spatial area, and the impact definitions to detect a potential impact; and
send an impact notification to the first client system and the second client system.

13. The system of claim 12, wherein the save event identifies a part or assembly in the first spatial area that has had geometry or component changes, and wherein the instructions cause the computing system to perform the impact detection by:
performing a where-used query on the part or assembly to determine where-used results;
determining whether the where-used results correspond to an impact definition; and
for each where used result that corresponds to an impact definition, evaluating the geometry or component changes with respect to the impact definitions to identify the potential impact.

14. The system of claim 12, wherein the instructions cause the computing system to send an impact notification to the first client system and the second client system including by sending the impact notification to a message broker that publishes the impact notification to the first client system and second client system.

15. The system of claim 12, wherein the notification of a save event is received from a message broker.

16. The system of claim 12 wherein the first client system displays a 3D graphical feedback to a user illustrating the potential impact.

17. The system of claim 12, wherein the first client system displays an impact analysis dashboard that includes collective or historical information of impacts over time.

18. The system of claim 12, wherein the impact notification includes one or more of an identifier of a client that produced the save event that resulted in the impact notification, a name or type of design tool that produced the save event that resulted in the impact notification, a spatial area affected by the save event that resulted in the impact notification, universal identifiers of any parts or components changed, added, or deleted by the save event that resulted in the impact notification, geometric, CAx, or other data that can be used to display the potential impact, or a username or other identifier of a user of a client that produced the save event that resulted in the impact notification.

19. A non-transitory machine-readable medium storing instructions that, when executed by a processor, cause a computing system to:
access a computer-aided design, engineering, visualization, or manufacturing (CAx) model of a part or assembly to be manufactured;
store a plurality of impact definitions corresponding to the CAx model;
receive, from a first client system, an indication of a first spatial area of the CAx model and, from a second client system, an indication of a second spatial area of the CAx model;
receive a notification of a save event created by the first client system for the first spatial area;
perform impact detection according to the save event, the first spatial area, and the impact definitions to detect a potential impact; and
send an impact notification to the first client system and the second client system.

20. The non-transitory machine-readable medium of claim 19, wherein the save event identifies a part or assembly in the first spatial area that has had geometry or component changes, and wherein the instructions cause the computing system to perform the impact detection by:
performing a where-used query on the part or assembly to determine where-used results;
determining whether the where-used results correspond to an impact definition; and
for each where used result that corresponds to an impact definition, evaluating the geometry or component changes with respect to the impact definitions to identify the potential impact.

21. The non-transitory machine-readable medium of claim 19, wherein the instructions cause the computing system to send an impact notification to the first client system and the second client system including by sending the impact notification to a message broker that publishes the impact notification to the first client system and second client system.

22. The non-transitory machine-readable medium of claim 19 wherein the first client system displays a 3D graphical feedback to a user illustrating the potential impact.

23. The non-transitory machine-readable medium of claim 19, wherein the first client system displays an impact analysis dashboard that includes collective or historical information of impacts over time.

24. The non-transitory machine-readable medium of claim 19, wherein the impact notification includes one or more of an identifier of a client that produced the save event that resulted in the impact notification, a name or type of design tool that produced the save event that resulted in the impact notification, a spatial area affected by the save event that resulted in the impact notification, universal identifiers of any parts or components changed, added, or deleted by the save event that resulted in the impact notification, geometric, CAx, or other data that can be used to display the potential impact, or a username or other identifier of a user of a client that produced the save event that resulted in the impact notification.
